(19) United States
(12) Patent Application Publication
(10) Pub. No.: US 2018/0027009 A1
(43) Pub. Date: Jan. 25, 2018

(54) AUTOMATED CONTAINER SECURITY

(71) Applicant: Cisco Technology, Inc., San Jose, CA (US)

(72) Inventors: Omar Santos, Raleigh, NC (US); Jazib Frahim, Cary, NC (US)

(21) Appl. No.: 15/215,494

(22) Filed: Jul. 20, 2016

(51) Int. Cl. H04L 29/06

(52) U.S. Cl. CPC H04L 63/1433; H04L 63/1441

(57) ABSTRACT

Systems, methods, and computer-readable storage media for determining threat mitigation policies and deploying tested security fixes. In some cases, the present technology involves gathering threat intelligence, identifying a security threat, identifying an application container that is affected by the security threat, determining a threat level for the security threat on the application container, applying a threat mitigation policy to the affected application container, spawning a clone of the affected application container, testing the clone with one or more security fixes, and deploying the clone of the affected container as a replacement for the affected container.

### TECHNICAL FIELD

The present technology pertains to threat analysis and remediation. More specifically, the present technology involves determining threat mitigation policies and deploying tested security fixes.

### BACKGROUND

Cloud computing offers numerous benefits including the ability to provision, compute and store on-demand resources for distributed networks. Cloud infrastructure also supports resource conserving solutions such as virtual machines, operating-system-level virtualization containers (also referred to as “application containers”), etc. Additionally, software solutions (e.g. DOCKER) have developed to automate the building, deployment, execution, maintenance, etc. of application containers.

The adoption of application containers has been widespread due to their technical and business advantages including rapid application deployment, sharing of containers with others, and having a lightweight footprint. Application containers also can include an API-based management, an image format, and the use of a remote registry for sharing containers—which benefit both developers and system administrators to enable rapid application deployment.

Despite these benefits, application containers can create serious issues within a cloud infrastructure when potential security vulnerabilities or actual security exploits affect a container. Additionally, the deployment of security patches to application containers before the patches are adequately tested in a similar operating environment can cause numerous problems with operability of the container and interoperability between the container and other systems. Currently, there is no solution for automated vulnerability risk analysis or for testing vulnerability fixes to ensure that they adequately address vulnerabilities or exploits without creating additional issues.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates a schematic block diagram of an example cloud architecture including nodes/devices interconnected by various methods of communication;

FIG. 2 illustrates a schematic block diagram of an example cloud controller;

FIG. 3A illustrates example architecture for automating the deployment and management of operating-system-level virtualization software containers;

FIG. 3B illustrates example architecture for automating the deployment and management of geographically dispersed and functionally diverse operating-system-level virtualization software containers;

FIG. 4A illustrates an example threat analyzer in a system for automating the deployment and management of geographically dispersed and functionally diverse operating-system-level virtualization software containers;

FIG. 4B illustrates an example threat analyzer engine and a clone application container;

FIG. 5 illustrates an example method of applying a threat mitigation policy to application containers based on a threat level determined by a threat analyzer;

FIG. 6 illustrates an example method of cloning a security container for regression testing and deployment of a tested clone container;

FIG. 7 illustrates an example method of applying threat mitigation policies and deploying cloned containers;

FIG. 8 illustrates an example network device suitable for implementing automatic link security; and

FIG. 9A and FIG. 9B illustrate example system embodiments.

### DESCRIPTION OF EXAMPLE EMBODIMENTS

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

### Overview

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

As explained above, the adoption of application containers has been widespread, but can create serious issues within a cloud infrastructure when potential security vulnerabilities or actual security exploits are identified. The present technology involves system, methods, and computer-readable media for rapidly performing vulnerability risk analysis based on threat intelligence and indicators of compromise and local environmental factors, automating the testing of the vulnerability fix, enforcing policies within each container or network device while the test of the vulnerability fix is complete, or automating the patching of the application within each container after an automated regression testing is complete.

In some cases, the present technology involves a threat analyzer engine in a network architecture gathering threat intelligence from a variety of sources and correlating the threat intelligence to identify a security threat. The threat analyzer engine can also automatically identify an application container that is affected by the security threat and determine a threat level for the security threat on the application container. Based on the threat level, the threat analyzer can select and apply a threat mitigation policy to the affected application container.

In some cases, the present technology involves a threat analyzer engine in a network architecture identifying a security threat for an application container and spawning a clone of the affected application container. The threat analyzer can also perform regression testing with one or more security fixes on the clone of the affected application container while also taking into account the operating environment of the affected application. Once the security fix is successful tested in the cloned application container, the threat analyzer can deploy the clone of the affected container as a replacement for the affected container.

In some cases, the present technology involves a threat analyzer engine in a network architecture gathering security threat intelligence for potential security threats to one or more application container in the network. Gathering security threat intelligence can involve gathering external intelligence relating to an active exploit that affected another application container, processing a vulnerability report from a commercial vendor, processing a vulnerability report from a governmental organization, and analyzing local indicators of compromise, etc.

The threat analyzer engine can also identify a security threat by correlating the threat intelligence with local indicators of compromise to identify affected application containers. The threat analyzer can then automatically identify an application container that is affected by the security threat and gather information relating to the operating environment of the affected application container.

Next, in some cases the threat analyzer engine can determine a threat level for the security threat on the application container, apply the information relating to the operating environment of the affected application container, and apply a threat mitigation policy on the affected application container based on the threat level. In some cases, the threat mitigation policy on the affected application container involves one or more of: hardening an access policy for the affected application container, encrypting a database for the affected application container, suspending a service offered by the affected application container, and shutting down the affected application container.

Additionally, the threat analyzer engine can spawn a clone of the affected application container, apply the information relating to the operating environment of the affected application container to the clone of the affected application container, and test one or more security fixes on the clone of the affected application container. Once the threat analyzer successfully test a security fix in the clone container, the threat analyzer engine can deploy the clone of the affected container as a replacement for the affected container.

### Description

A computer network can include a system of hardware, software, protocols, and transmission components that collectively allow separate devices to communicate, share data, and access resources, such as software applications. More specifically, a computer network is a geographically distributed collection of nodes interconnected by communication links and segments for transporting data between endpoints, such as personal computers and workstations. Many types of networks are available, ranging from local area networks (LANs) and wide area networks (WANs) to overlay and software-defined networks, such as virtual extensible local area networks (VXLANs), and virtual networks such as virtual LANs (VLANs) and virtual private networks (VPNs).

LANs typically connect nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links. LANs and WANs can include layer 2 (L2) and/or layer 3 (L3) networks and devices.

The Internet is an example of a public WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol can refer to a set of rules defining how the nodes interact with each other. Computer networks may be further interconnected by intermediate network nodes, such as routers, switches, hubs, or access points (Aps), which can effectively extend the size or footprint of the network.

Networks can be segmented into subnetworks to provide a hierarchical, multilevel routing structure. For example, a network can be segmented into subnetworks using subnet addressing to create network segments. This way, a network can allocate various groups of IP addresses to specific network segments and divide the network into multiple logical networks.

In addition, networks can be divided into logical segments called virtual networks, such as VLANs, which connect logical segments. For example, one or more LANs can be logically segmented to form a VLAN. A VLAN allows a group of machines to communicate as if they were in the same physical network, regardless of their actual physical location. Thus, machines located on different physical LANs can communicate as if they were located on the same physical LAN. Interconnections between networks and devices can also be created using routers and tunnels, such as VPN or secure shell (SSH) tunnels. Tunnels can encrypt point-to-point logical connections across an intermediate network, such as a public network like the Internet. This allows secure communications between the logical connections and across the intermediate network. By interconnecting networks, the number and geographic scope of machines interconnected, as well as the amount of data, resources, and services available to users can be increased.

Further, networks can be extended through network virtualization. Network virtualization allows hardware and software resources to be combined in a virtual network. For example, network virtualization can allow multiple numbers of VMs to be attached to the physical network via respective VLANs. The VMs can be grouped according to their respective VLAN, and can communicate with other VMs as well as other devices on the internal or external network.

To illustrate, overlay networks generally allow virtual networks to be created and layered over a physical network infrastructure. Overlay network protocols, such as Virtual Extensible LAN (VXLAN), Network Virtualization using Generic Routing Encapsulation (NVGRE), Network Virtualization Overlays (NVO3), and Stateless Transport Tunneling (STT), provide a traffic encapsulation scheme which allows network traffic to be carried across L2 and L3 networks over a logical tunnel. Such logical tunnels can be originated and terminated through virtual tunnel end points (VTEPs).

Moreover, overlay networks can include virtual segments, such as VXLAN segments in a VXLAN overlay network, which can include virtual L2 and/or L3 overlay networks over which VMs communicate. The virtual segments can be identified through a virtual network identifier (VNI), such as a VXLAN network identifier, which can specifically identify an associated virtual segment or domain.

Networks can include various hardware or software appliances or nodes to support data communications, security, and provision services. For example, networks can include routers, hubs, switches, APs, firewalls, repeaters, intrusion detectors, servers, VMs, load balancers, application delivery controllers (ADCs), and other hardware or software appliances. Such appliances can be distributed or deployed over one or more physical, overlay, or logical networks. Moreover, appliances can be deployed as clusters, which can be formed using layer 2 (L2) and layer 3 (L3) technologies. Clusters can provide high availability, redundancy, and load balancing for flows associated with specific appliances or nodes. A flow can include packets that have the same source and destination information. Thus, packets originating from device A to service node B can all be part of the same flow.

Endpoint groups (EPGs) can also be used in a network for mapping applications to the network. In particular, EPGs can use a grouping of application endpoints in a network to apply connectivity and policy to the group of applications. EPGs can act as a container for groups or collections of applications, or application components, and tiers for implementing forwarding and policy logic. EPGs also allow separation of network policy, security, and forwarding from addressing by instead using logical application boundaries.

Appliances or nodes, as well as clusters, can be implemented in cloud deployments. Cloud deployments can be provided in one or more networks to provision computing services using shared resources. Cloud computing can generally include Internet-based computing in which computing resources are dynamically provisioned and allocated to client or user computers or other devices on-demand, from a collection of resources available via the network (e.g., “the cloud”). Cloud computing resources, for example, can include any type of resource, such as computing, storage, network devices, applications, virtual machines (VMs), services, and so forth. For instance, resources may include service devices (firewalls, deep packet inspectors, traffic monitors, load balancers, etc.), compute/processing devices (servers, CPU's, memory, brute force processing capability), storage devices (e.g., network attached storages, storage area network devices), etc. In addition, such resources may be used to support virtual networks, virtual machines (VM), databases, applications (Apps), etc. Also, services may include various types of services, such as monitoring services, management services, communication services, data services, bandwidth services, routing services, configuration services, wireless services, architecture services, etc.

The cloud may include a “private cloud,” a “public cloud,” and/or a “hybrid cloud.” A “hybrid cloud” can be a cloud infrastructure composed of two or more clouds that inter-operate or federate through technology. In essence, a hybrid cloud is an interaction between private and public clouds where a private cloud joins a public cloud and utilizes public cloud resources in a secure and scalable manner. In some cases, the cloud can be include one or more cloud controllers which can help manage and interconnect various elements in the cloud as well as tenants or clients connected to the cloud.

Cloud controllers and/or other cloud devices can be configured for cloud management. These devices can be pre-configured (i.e, come “out of the box”) with centralized management, layer 7 (L7) device and application visibility, real time web-based diagnostics, monitoring, reporting, management, and so forth. As such, in some embodiments, the cloud can provide centralized management, visibility, monitoring, diagnostics, reporting, configuration (e.g., wireless, network, device, or protocol configuration), traffic distribution or redistribution, backup, disaster recovery, control, and any other service. In some cases, this can be done without the cost and complexity of specific appliances or overlay management software.

The disclosed technology addresses the need in the art for improved container security. The present technology involves system, methods, and computer-readable media for rapidly performing vulnerability risk analysis based on threat intelligence and indicators of compromise and local environmental factors, automating the testing of the vulnerability fix, enforcing policies within each container or network device while the test of the vulnerability fix is complete, or automating the patching of the application within each container after an automated regression testing is complete.

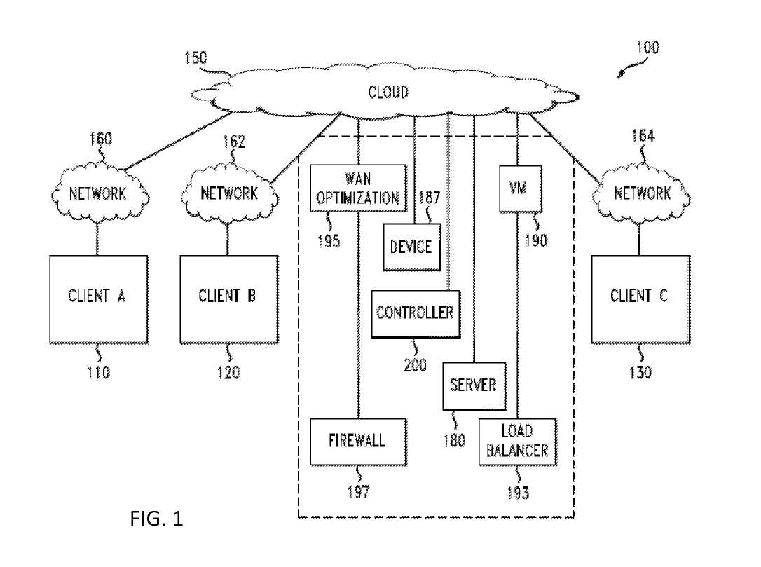

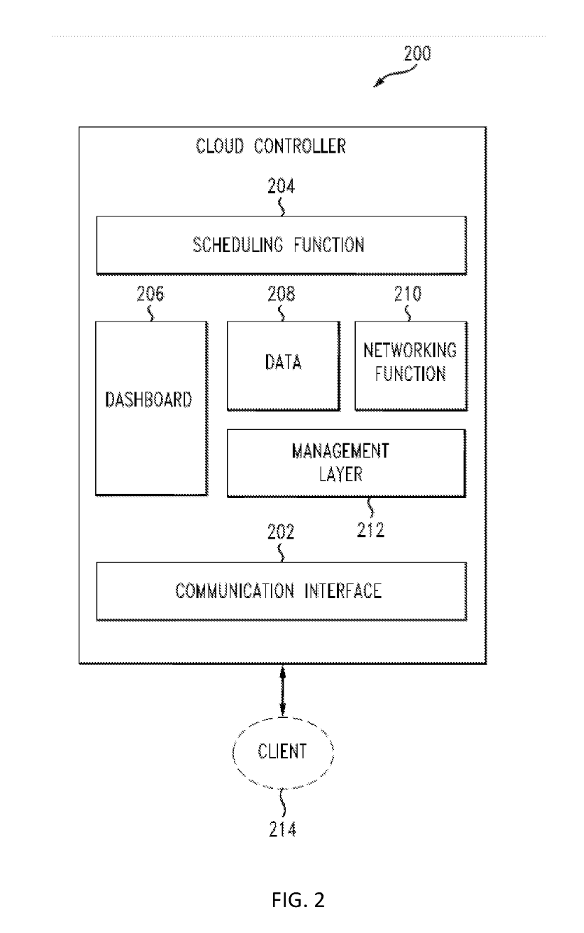

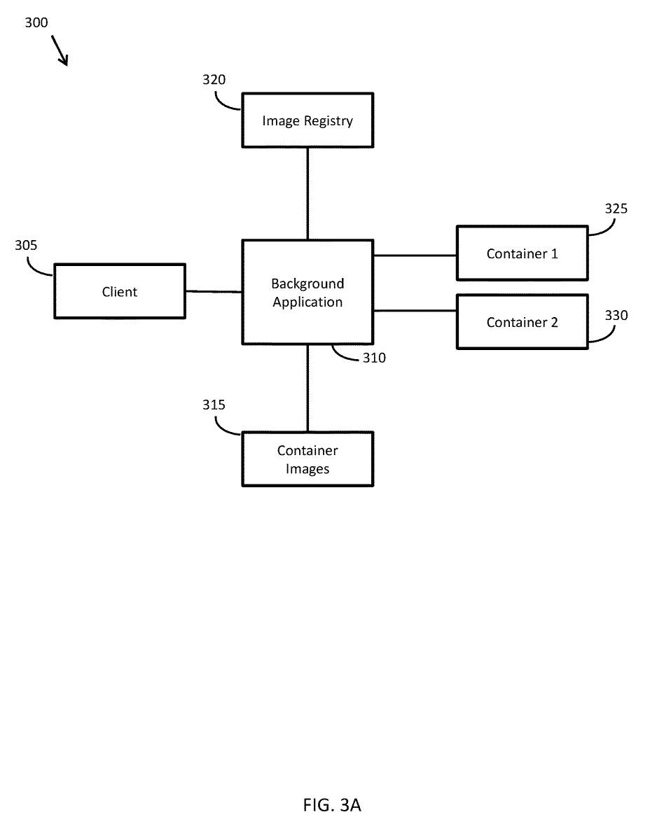

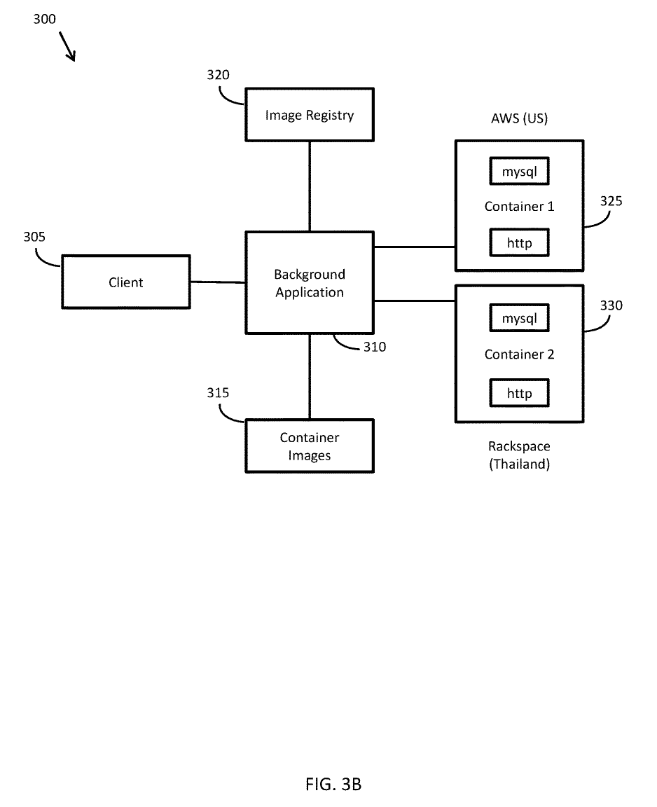

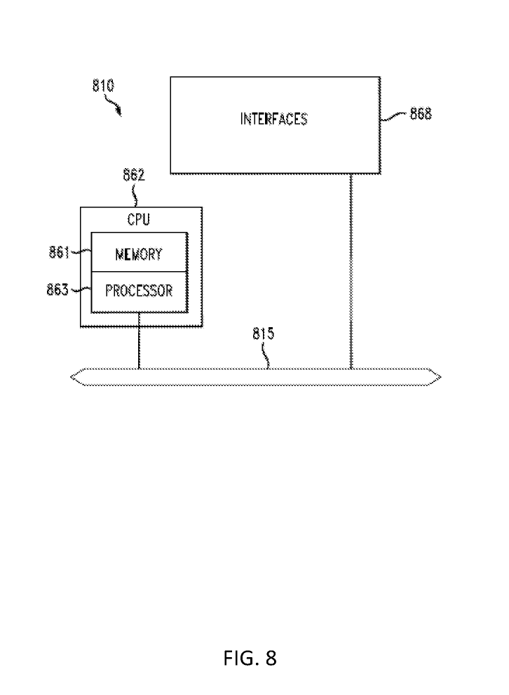

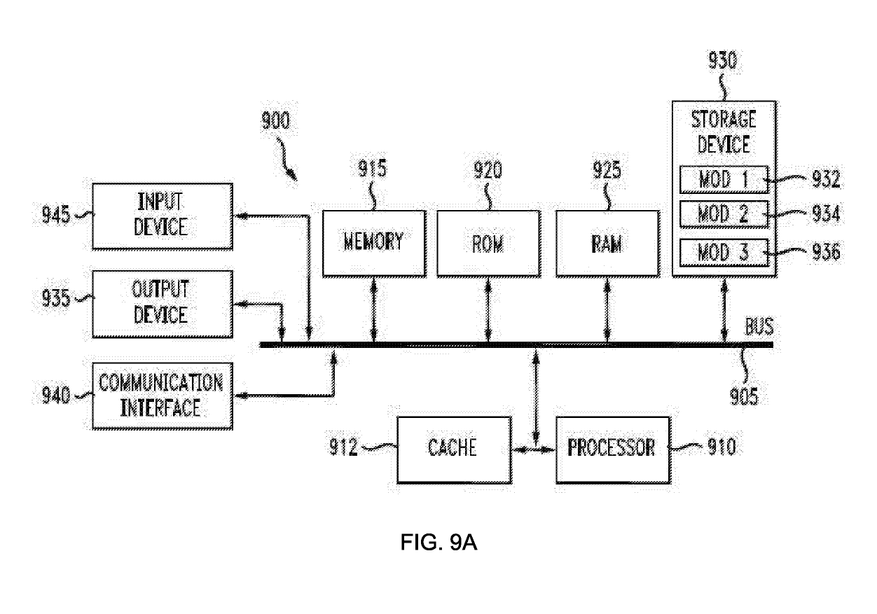

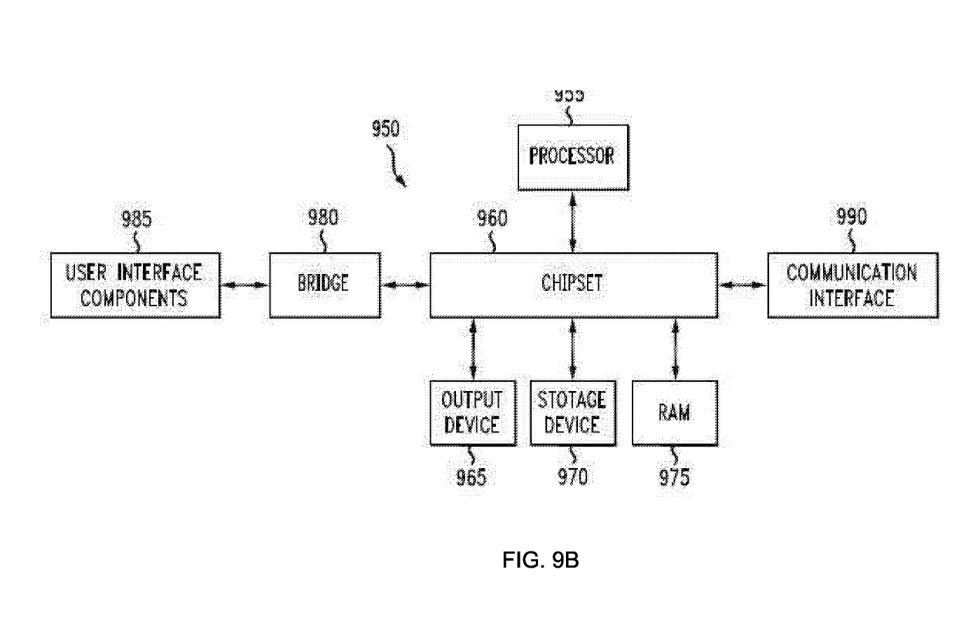

A description of cloud computing environments, as illustrated in FIGS. 1 and 2, is first disclosed herein. A discussion of container security and, including examples and variations, as illustrated in FIGS. 3A-7, will then follow. The discussion then concludes with a brief description of example devices, as illustrated in FIGS. 8 and 9A-B. These variations shall be described herein as the various embodiments are set forth. The disclosure now turns to FIG. 1.

FIG. 1 illustrates a schematic block diagram of an example cloud architecture 100 including nodes/devices interconnected by various methods of communication. Cloud 150 can be a public, private, and/or hybrid cloud system. Cloud 150 can include resources, such as one or more Firewalls 197; Load Balancers 193; WAN optimization platforms 195; devices 187, such as switches, routers, intrusion detection systems, Auto VPN systems, or any hardware or software network device; servers 180, such as dynamic host configuration protocol (DHCP), domain naming system (DNS), or storage servers; virtual machines (VMs) 190; controllers 200, such as a cloud controller or a management device; or any other resource.

Cloud resources can be physical, software, virtual, or any combination thereof. For example, a cloud resource can include a server running one or more VMs or storing one or more databases. Moreover, cloud resources can be provisioned based on requests (e.g., client or tenant requests), schedules, triggers, events, signals, messages, alerts, agreements, necessity, or any other factor. For example, the cloud 150 can provision application services, storage services, management services, monitoring services, configuration services, administration services, backup services, disaster recovery services, bandwidth or performance services, intrusion detection services, VPN services, or any type of services to any device, server, network, client, or tenant.

In addition, cloud 150 can handle traffic and/or provision services. For example, cloud 150 can provide configuration services, such as auto VPN, automated deployments, automated wireless configurations, automated policy implementations, and so forth. In some cases, the cloud 150 can collect data about a client or network and generate configuration settings for specific service, device, or networking deployments. For example, the cloud 150 can generate security policies, subnetting and routing schemes, forwarding schemes, NAT settings, VPN settings, and/or any other type of configurations. The cloud 150 can then push or transmit the necessary data and settings to specific devices or components to manage a specific implementation or deployment. For example, the cloud 150 can generate VPN settings, such as IP mappings, port number, and security information, and send the VPN settings to specific, relevant device(s) or component(s) identified by the cloud 150 or otherwise designated. The relevant device(s) or component(s) can then use the VPN settings to establish a VPN tunnel according to the settings.

To further illustrate, cloud 150 can provide specific services for client A (110), client B (120), and client C (130). For example, cloud 150 can deploy a network or specific network components, configure links or devices, automate services or functions, or provide any other services for client A (110), client B (120), and client C (130). Other non-limiting example services by cloud 150 can include network administration services, network monitoring services, content filtering services, application control, WAN optimization, firewall services, gateway services, storage services, protocol configuration services, wireless deployment services, and so forth.

To this end, client A (110), client B (120), and client C (130) can connect with cloud 150 through networks 160, 162, and 164, respectively. More specifically, client A (110), client B (120), and client C (130) can each connect with cloud 150 through networks 160, 162, and 164, respectively, in order to access resources from cloud 150, communicate with cloud 150, or receive any services from cloud 150. Networks 160, 162, and 164 can each refer to a public network, such as the Internet; a private network, such as a LAN; a combination of networks; or any other network, such as a VPN or an overlay network.

Moreover, client A (110), client B (120), and client C (130) can each include one or more networks. For example, (110), client B (120), and client C (130) can each include one or more LANs and VLANs. In some cases, a client can represent one branch network, such as a LAN, or multiple branch networks, such as multiple remote networks. For example, client A (110) can represent a single LAN network or branch, or multiple branches or networks, such as a branch building or office network in Los Angeles and another branch building or office network in New York. If a client includes multiple branches or networks, the multiple branches or networks can each have a designated connection to the cloud 150. For example, each branch or network can maintain a tunnel to the cloud 150. Alternatively, all branches or networks for a specific client can connect to the cloud 150 via one or more specific branches or networks. For example, traffic for the different branches or networks of a client can be routed through one or more specific branches or networks. Further, client A (110), client B (120), and client C (130) can each include one or more routers, switches, appliances, client devices, VMs, or any other devices. In some cases, client A (110), client B (120), and/or client C (130) can also maintain links between branches. For example, client A can have two branches, and the branches can maintain a link between each other.

In some cases, branches can maintain a tunnel between each other, such as a VPN tunnel. Moreover, the link or tunnel between branches can be generated and/or maintained by the cloud 150. For example, the cloud 150 can collect network and address settings for each branch and use those settings to establish a tunnel between branches. In some cases, the branches can use a respective tunnel between the respective branch and the cloud 150 to establish the tunnel between branches. For example, branch 1 can communicate with cloud 150 through a tunnel between branch 1 and cloud 150 to obtain the settings for establishing a tunnel between branch 1 and branch 2. Branch 2 can similarly communicate with cloud 150 through a tunnel between branch 2 and cloud 150 to obtain the settings for the tunnel between branch 1 and branch 2.

In some cases, cloud 150 can perform or support the application of threat mitigation policies and the deployment of tested clone containers, as further described below in FIGS. 3A-7. Cloud 150 can also maintain one or more links or tunnels to client A (110), client B (120), and client C (130). For example, cloud 150 can maintain a VPN tunnel to one or more devices in client A's network. In some cases, cloud 150 can configure the VPN tunnel for a client, maintain the VPN tunnel, or automatically update or establish any link or tunnel to the client or any devices of the client.

The cloud 150 can also monitor device and network health and status information for client A (110), client B (120), and client C (130). To this end, client A (110), client B (120), and client C (130) can synchronize information with cloud 150. Cloud 150 can also manage and deploy services for client A (110), client B (120), and client C (130). For example, cloud 150 can collect network information about client A and generate network and device settings to automatically deploy a service for client A. In addition, cloud 150 can update device, network, and service settings for client A (110), client B (120), and client C (130). For example, cloud 150 can negotiate automatic link security for a connection with client A, as further described below.

Those skilled in the art will understand that the cloud architecture 150 can include any number of nodes, devices, links, networks, or components. In fact, embodiments with different numbers and/or types of clients, networks, nodes, cloud components, servers, software components, devices, virtual or physical resources, configurations, topologies, services, appliances, deployments, or network devices are also contemplated herein. Further, cloud 150 can include any number or type of resources, which can be accessed and utilized by clients or tenants. The illustration and examples provided herein are for clarity and simplicity.

Moreover, as far as communications within the cloud architecture 100, packets (e.g., traffic and/or messages) can be exchanged among the various nodes and networks in the cloud architecture 100 using specific network communication protocols. In particular, packets can be exchanged using wired protocols, wireless protocols, or any other protocols. Some non-limiting examples of protocols can include protocols from the Internet Protocol Suite, such as TCP/IP; OSI (Open Systems Interconnection) protocols, such as L1-L7 protocols; routing protocols, such as RIP, IGP, BGP, STP, ARP, OSPF, EIGRP, NAT; or any other protocols or standards, such as HTTP, SSH, SSL, RTP, FTP, SMTP, POP, PPP, NNTP, IMAP, Telnet, SSL, SFTP, WIFI, Bluetooth, VTP, ISL, IEEE 802 standards, L2TP, IPSec, etc. In addition, various hardware and software components or devices can be implemented to facilitate communications both within a network and between networks. For example, switches, hubs, routers, access points (APs), antennas, network interface cards (NICs), modules, cables, firewalls, servers, repeaters, sensors, etc.

FIG. 2 illustrates a schematic block diagram of an example cloud controller 200. The cloud controller 200 can serve as a cloud service management system for the cloud 150. In particular, the cloud controller 200 can manage cloud operations, client communications, service provisioning, network configuration and monitoring, etc. For example, the cloud controller 200 can manage cloud service provisioning, such as cloud storage, media, streaming, security, or administration services. In some embodiments, the cloud controller 200 can perform or support the application of threat mitigation policies and the deployment of tested clone containers, as further described in FIGS. 3A-7 below.

The cloud controller 200 can also include several subcomponents, such as a scheduling function 204, a dashboard 206, data 208, a networking function 210, a management layer 212, and a communications interface 202. The various subcomponents can be implemented as hardware and/or software components. Moreover, although FIG. 2 illustrates one example configuration of the various components of the cloud controller 200, those of skill in the art will understand that the components can be configured in a number of different ways and can include any other type and number of components. For example, the networking function 210 and management layer 212 can belong to one software module or multiple separate modules. Other modules can be combined or further divided up into more subcomponents.

The scheduling function 204 can manage scheduling of procedures, events, or communications. For example, the scheduling function 204 can schedule when resources should be allocated from the cloud 150. As another example, the scheduling function 204 can schedule when specific instructions or commands should be transmitted to the client 214. In some cases, the scheduling function 204 can provide scheduling for operations performed or executed by the various subcomponents of the cloud controller 200. The scheduling function 204 can also schedule resource slots, virtual machines, bandwidth, device activity, status changes, nodes, updates, etc.

The dashboard 206 can provide a frontend where clients can access or consume cloud services. For example, the dashboard 206 can provide a web-based frontend where clients can configure client devices or networks that are cloud-managed, provide client preferences, specify policies, enter data, upload statistics, configure interactions or operations, etc. In some cases, the dashboard 206 can provide visibility information, such as views of client networks or devices. For example, the dashboard 206 can provide a view of the status or conditions of the client's network, the operations taking place, services, performance, a topology or layout, specific network devices, protocols implemented, running processes, errors, notifications, alerts, network structure, ongoing communications, data analysis, etc.

Indeed, the dashboard 206 can provide a graphical user interface (GUI) for the client 214 to monitor the client network, the devices, statistics, errors, notifications, etc., and even make modifications or setting changes through the GUI. The GUI can depict charts, lists, tables, maps, topologies, symbols, structures, or any graphical object or element. In addition, the GUI can use color, font, shapes, or any other characteristics to depict scores, alerts, or conditions. In some cases, the dashboard 206 can also handle user or client requests. For example, the client 214 can enter a service request through the dashboard 206.

The data 208 can include any data or information, such as management data, statistics, settings, preferences, profile data, logs, notifications, attributes, configuration parameters, client information, network information, and so forth. For example, the cloud controller 200 can collect network statistics from the client 214 and store the statistics as part of the data 208. In some cases, the data 208 can include performance and/or configuration information. This way, the cloud controller 200 can use the data 208 to perform management or service operations for the client 214. The data 208 can be stored on a storage or memory device on the cloud controller 200, a separate storage device connected to the cloud controller 200, or a remote storage device in communication with the cloud controller 200.

The networking function 210 can perform networking calculations, such as network addressing, or networking service or operations, such as auto VPN configuration or traffic routing. For example, the networking function 210 can perform filtering functions, switching functions, security threat mitigation functions, deployment of tested clone container functions, network or device deployment functions, resource allocation functions, messaging functions, traffic analysis functions, port configuration functions, mapping functions, packet manipulation functions, path calculation functions, loop detection, cost calculation, error detection, or otherwise manipulate data or networking devices. In some embodiments, the networking function 210 can handle networking requests from other networks or devices and establish links between devices. In other embodiments, the networking function 210 can perform queueing, messaging, or protocol operations.

The management layer 212 can include logic to perform management operations. For example, the management layer 212 can include the logic to allow the various components of the cloud controller 200 to interface and work together. The management layer 212 can also include the logic, functions, software, and procedure to allow the cloud controller 200 perform monitoring, management, control, and administration operations of other devices, the cloud 150, the client 214, applications in the cloud 150, services provided to the client 214, or any other component or procedure. The management layer 212 can include the logic to operate the cloud controller 200 and perform particular services configured on the cloud controller 200.

Moreover, the management layer 212 can initiate, enable, or launch other instances in the cloud controller 200 and/or the cloud 150. In some embodiments, the management layer 212 can also provide authentication and security services for the cloud 150, the client 214, the controller 214, and/or any other device or component. Further, the management layer 212 can manage nodes, resources, VMs, settings, policies, protocols, communications, etc. In some embodiments, the management layer 212 and the networking function 210 can be part of the same module. However, in other embodiments, the management layer 212 and networking function 210 can be separate layers and/or modules. The communications interface 202 allows the cloud controller 200 to communicate with the client 214, as well as any other device or network. The communications interface 202 can be a network interface card (NIC), and can include wired and/or wireless capabilities. The communications interface 202 allows the cloud controller 200 to send and receive data from other devices and networks. In some embodiments, the cloud controller 200 can perform or support the application of threat mitigation policies and the deployment of tested clone containers, as described in more detail below.

As explained above, the adoption of application containers and container management software (e.g. Docker) have been widespread due to their technical and business advantages including rapid application deployment, sharing of containers with others, and having a lightweight footprint. The present technology involves system, methods, and computer-readable media for rapidly performing vulnerability risk analysis based on threat intelligence and indicators of compromise and local environmental factors, automating the testing of the vulnerability fix, enforcing policies within each container or network device while the test of the vulnerability fix is complete, or automating the patching of the application within each container after an automated regression testing is complete.

Portions of the disclosure refer specifically to Linux Containers, DOCKER software, etc.; however, those with ordinary skill in the art having the benefit of the disclosure will readily appreciate that the present technology can be used and can benefit a wide range of other distributed software environments using software containers, virtual machines, software defined networking (SDN) controllers, endpoint groups, etc.

FIG. 3A illustrates example architecture 300 for automating the deployment and management of operating-system-level virtualization software containers. The architecture 300 of FIG. 3A includes a client 305 in communication with a background application 310 (e.g. daemon). The background application 310 is in communication with container images 315, an image registry 320, and containers 325, 330. The example architecture 300 of FIG. 3 is a version of architecture that can become much more complicated when containers are distributed across geographical and functional environments. FIG. 3B illustrates example architecture 350 for automating the deployment and management of geographically dispersed and functionally diverse operating-system-level virtualization software containers. The architecture 350 of FIG. 3B involves a client 355 in communication with a background process 360 which is in communication with container images 365 and a registry 370.

Also, the architecture 350 in FIG. 3B includes containers 375, 380 which respectively include an application that uses a web-service (HTTP server) and an integrated relational database (e.g., MySQL) are deployed in two separate cloud providers (e.g. AWS in the United States and Rackspace in Thailand). Due to the dynamic nature of external factors such as threat actor activities, indicators of compromise, and application vulnerabilities the posture, the protection, and the patching of the application running in such containers can be extremely difficult to address. For example, as a threat activity around a known vulnerability, or even an unknown activity (e.g., a new variant of ransomware) is identified in a region, in a cloud provider, or even in a data-center, the containers must be protected with the appropriate security controls to mitigate the threat, the vulnerability patch needs to be tested and then deployed.

Before the present technology, there was no framework that leveraged threat information (external or local) and known and unknown vulnerabilities for automated impact assessment, mitigation and patching. Accordingly, the present technology involves a multi-function threat engine responsible for determining the appropriate action to a threat and complete vulnerability management for one or multiple containers. Accordingly, some embodiments of the present technology involve a threat engine configured to correlate threat intelligence, indicators of compromise, rapidly perform vulnerability risk analysis based on such threat intelligence, indicators of compromise and local environmental factors; automate the testing of the vulnerability fix (i.e. patch); enforce policies within each container or network device while the test of the vulnerability fix is complete; and automate the patching of the application within each container after the automated regression testing is complete.

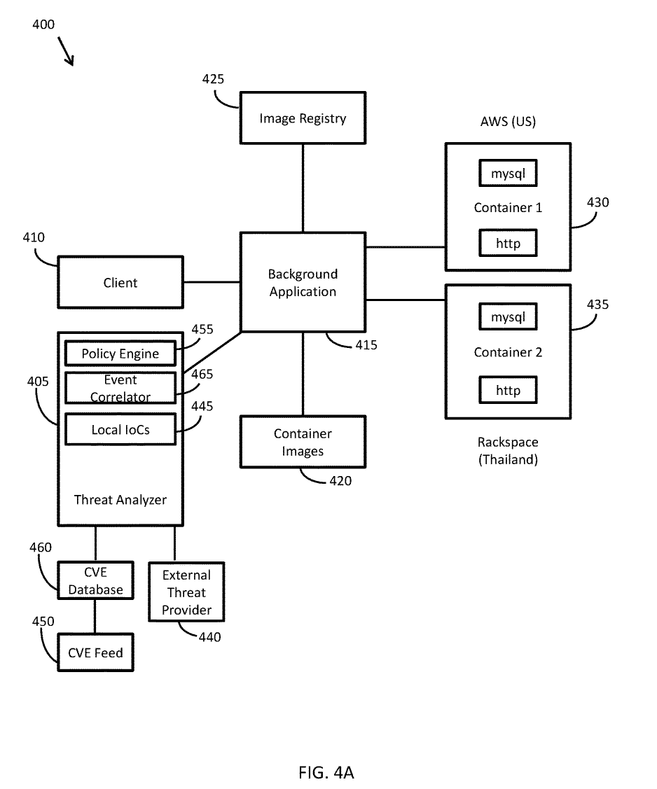

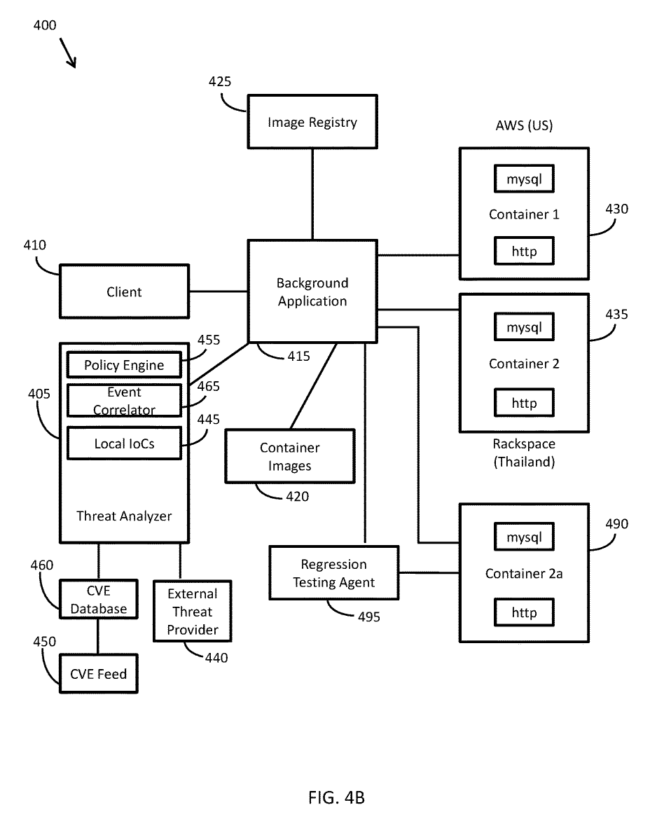

FIG. 4A illustrates an example threat analyzer 405 in a system 400 for automating the deployment and management of geographically dispersed and functionally diverse operating-system-level virtualization software containers. As in the example architectures described above, the system 400 involves a client 410 in communication with a background application 415 which itself is in communication with a registry 425 and container images 420. Also, the system 400 involves geographically-dispersed and functionally diverse application containers 430, 435. In addition, the system involves a threat analyzer 405 configured to dynamically harden container upon the detection of a threat activity, while testing the vulnerability fix, and then applying such fix in an automated fashion.

In some cases, the threat analyzer 405 gathers security threat intelligence by subscribing to external intelligence feeds from one or more external threat providers 440, analyzing local indicators of compromise (IoCs) 445 and receiving vulnerability reports (CVEs) from a CVE feed 450 from vendors or entities such as the National Vulnerability Database (NVD) and/or CVEs stored in a CVE database 460. In some cases, the IoCs can include communication to known malicious domains or IP addresses, DNS request anomalies, unusual outbound network traffic, anomalies in privileged user account activity, geographical irregularities of network traffic, swells in database read volume, HTML response sizes, large numbers of requests for the same file, etc.

The security threat intelligence and indicators of compromise ingested by the threat analyzer and/or the policy engine 455 can build an actionable threat mitigation policy that can be applied while a vulnerability patch is tested. For example, vulnerability patches can be tested in a separate container and then deployed, as described in more detail below. Additionally, the threat analyzer 405 can include an event correlator 465 that correlates threat intelligence and indicators of compromise to automatically identify containers affected by a security threat. For example, an IoC can involve a pattern for IP traffic beaconing to a specific command and control (C2, C&C) server. When the threat analyzer 405 detects that a MySQL server that is affected by a given vulnerability (CVE) now communicating to a known malicious C&C or an embargo country, the event correlator 465 can anticipate that the vulnerability has been exploited and that the risk is imminent. Another example is correlating vulnerability data (CVE data) with IoC information carried via a structured language for cyber threat intelligence (e.g. Structured Threat Information eXpression, Trusted Automated eXchange of Indicator Information, etc.)

The policy engine 455 can also identify the affected containers and send the threat mitigation policy to the background application (e.g. through RESTful APIs) for applying mitigation actions to the affected containers.

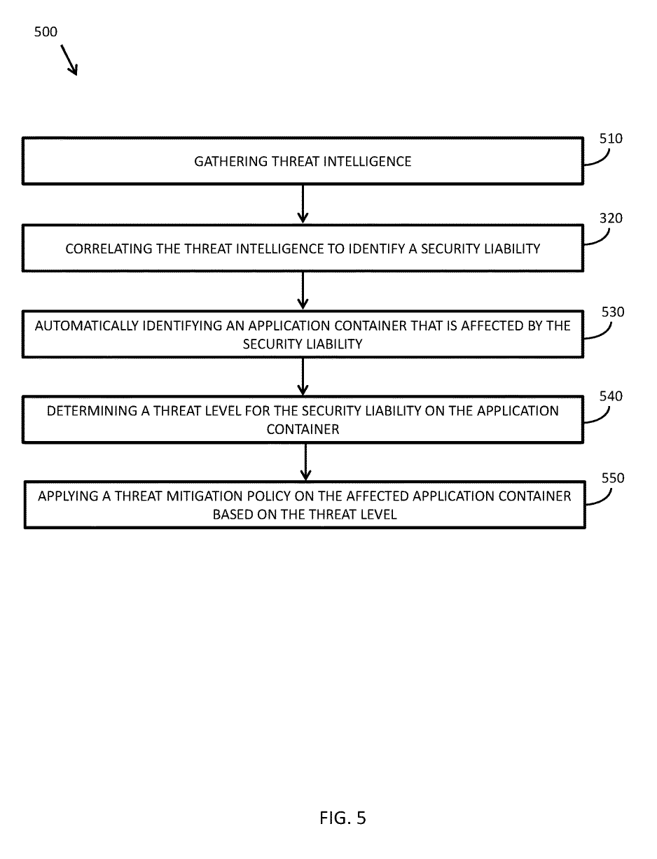

FIG. 5 illustrates an example method 500 of applying a threat mitigation policy to application containers based on a threat level determined by a threat analyzer. The method 500 involves gathering threat intelligence that can affect one or more containers 510. For example, gathering threat intelligence can include gathering external intelligence relating to an active exploit is affecting or has affected another application container in the past. Also, gathering threat intelligence can include processing vulnerability reports from a commercial vendor, processing a vulnerability report from a governmental organization, and analyzing local indicators of compromise.

Next, the method 500 involves correlating the threat intelligence to identify a security liability 520, automatically identifying an application container that is affected by the security liability 530, and determining a threat level for the security liability on the application container 540.

After a threat level is determined for affect application containers, the method 500 involves applying a threat mitigation policy to the affected application containers based on the threat level 550. Examples of threat mitigation policies can include hardening an access policy for the affected application container, encrypting a database for the affected application container, suspending a service offered by the affected application container, and shutting down the affected application container. Also, combinations of threat mitigation policies can be applied to affected application containers. In some cases, as a threat level escalates threat mitigation policies can be cumulatively applied. For example, a relatively low-level threat can result in the threat analyzer to causing the affected container to harden its access policy. Likewise, a mid-level threat can result in the threat analyzer causing the affected container to harden its access policy and encrypting its database. Also, a high-level threat can result in the threat analyzer causing the affected container to harden its access policy, encrypt its database, and suspend its services. Also, a critical-level threat can result in the threat analyzer causing the affected container to shut down until a security fix is successfully located, tested, and deployed.

As explained above, the deployment of security patches to application containers before the patches are adequately tested in a similar operating environment can cause numerous problems with operability of the container and interoperability between the container and other systems. Accordingly, some embodiments of the present technology involve gathering information about the operating environment of a container affected by a security threat, spawning clone containers, replicating the operating environment, and performing regression testing on the spawned clone in the replicated operating environment, patching the clone container with an acceptably tested security fix, and deploying the patched clone container to replace the container affected with the security threat.

Referring again to FIG. 4A, the threat analyzer can also be configured to spawn clone containers for application containers affected by a security threat, identify candidate fixes for addressing the security threats, and to perform regression testing on the clone containers before deploying the clone container to replace a container affected by a security threat.

FIG. 4B illustrates an example threat analyzer engine 405 configured to spawn a clone application container 490 for regression testing of security fixes in a system 400 for automating the deployment and management of geographically dispersed operating-system-level virtualization software containers 430, 435. As shown in FIG. 4B, the threat analyzer engine 405 can cause the background application 415 to spawn a clone application container 490. Also, a regression testing agent 495 can be configured to replicate the operating environment of the container affected with the security threat and perform regression testing on the spawned clone in the replicated operating environment. After the regression testing successfully identifies a security patch that does not introduce other issues to the operating environment, the spawned, tested clone application container can be deployed to replace the container affected with the security threat.

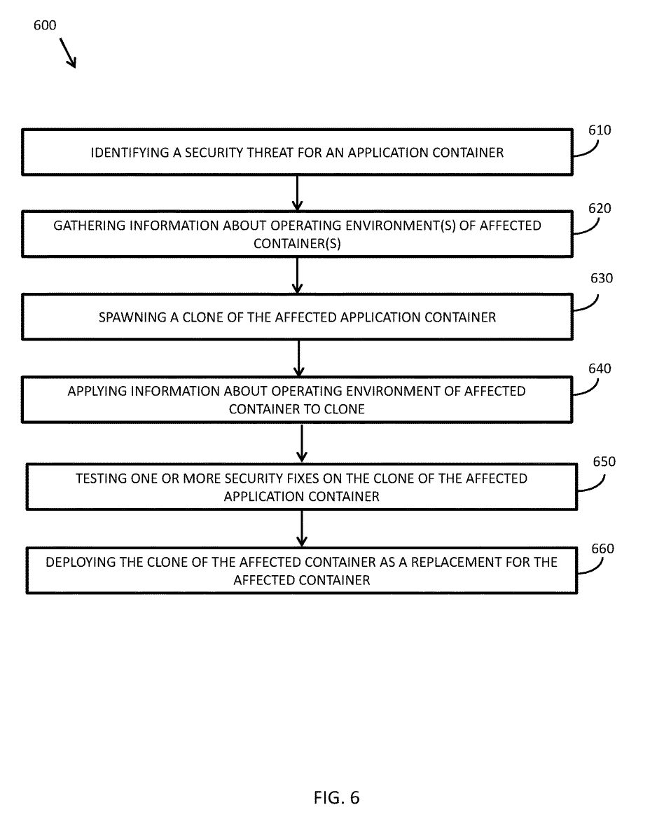

FIG. 6 illustrates an example method 600 of cloning a security container for regression testing and deployment of a tested clone container. The method 600 involves, identifying a security threat for an application container 610 and gathering information about the operating environment(s) of affected container(s) 620. Next, the method 600 involves spawning a clone of the affected application container(s) 630, applying information about operating environment of affected container to the clone(s) 640, and testing one or more security fixes on the clone of the affected application container 650. After regression testing successfully results in the one or more fixes adequately addressing the security threat in the spawned clone without introducing additional problems to the operating environment, the method 600 involves deploying the clone of the affected container as a replacement for the affected container 660.

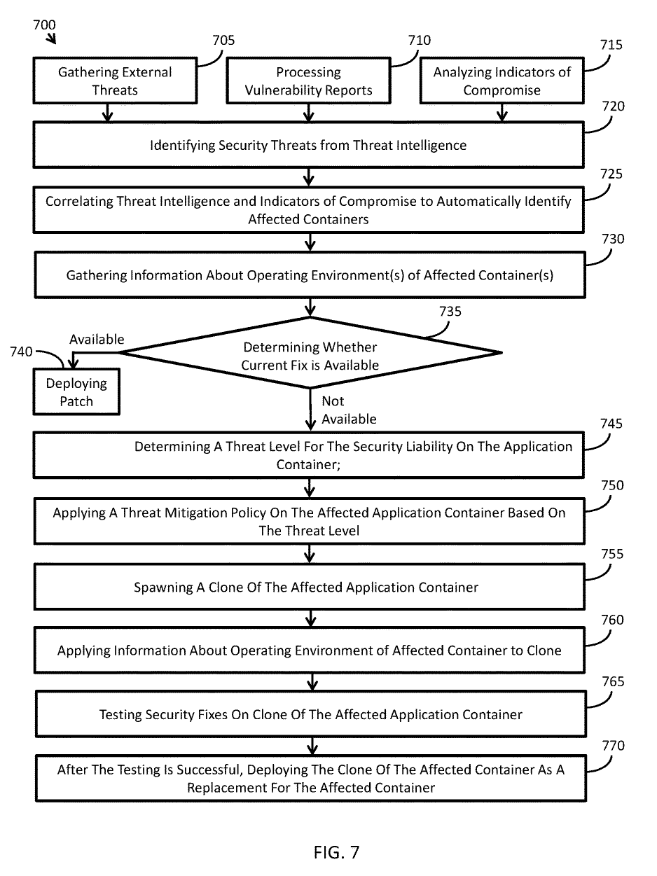

In some cases, synergistic effects are generated when both strategies of applying a threat mitigation policy for containers affected with security threats and deploying adequately tested container clones to replace containers affected with security threats are employed in combination. FIG. 7 illustrates an example method 700 of applying threat mitigation policies and deploying cloned containers.

The method 700 involves a threat analyzer gathering security threat intelligence in the form of gathering external threats 705, processing vulnerability reports 710, and analyzing indicators of compromise 715. Next, the method 700 involves identifying security threats for one or more application containers 720 based on the gathered security threat intelligence. In some cases, the method 700 involves correlating threat intelligence and indicators of compromise to automatically identify affected containers 725.

Next, the method 700 involves the threat analyzer gathering information about operating environment(s) of affected container(s) 730 and determining whether current fix is available 735. When a fix is already available for the identified security threat, the method 700 involves deploying the patch 740. However, when a current patch is not available for the affected container(s), the method 700 involves determining a threat level for the security liability on the application container 745.

Next, based on the determined threat level, the method 700 involves applying a threat mitigation policy on the affected application container 750. For example, applying a threat mitigation policy can involve one or more of: hardening an access policy for the affected application container, encrypting a database for the affected application container, suspending a service offered by the affected application container, and shutting down the affected application container.

As explained above, introducing a patch to an application container while the container is executing a service can create problems with other network operations. Accordingly, the method 700 involves spawning a clone of the affected application container 755, applying the gathered information about the operating environment of affected container to the clone 760, and testing security fixes on the clone of the affected application container 765. After the testing is successful, the method 700 can involve applying the successfully tested fix to the clone and deploying the clone of the affected container as a replacement for the affected container 770.

While the various examples above are described in terms of specific devices, such as appliances or branches, one of ordinary skill in the art will readily recognize that the concepts described herein can apply to other devices, networks, or environments.

FIG. 8 illustrates an example network device 810 suitable for implementing automated security threat mitigation and container fix testing and deployment. Network device 810 includes a master central processing unit (CPU) 862, interfaces 868, and a bus 815 (e.g., a PCI bus). When acting under the control of appropriate software or firmware, the CPU 862 is responsible for executing packet management, error detection, and/or routing functions. The CPU 862 preferably accomplishes all these functions under the control of software including an operating system and any appropriate applications software. CPU 862 may include one or more processors 863 such as a processor from the Motorola family of microprocessors or the MIPS family of microprocessors. In an alternative embodiment, processor 863 is specially designed hardware for controlling the operations of router 810. In a specific embodiment, a memory 861 (such as non-volatile RAM and/or ROM) also forms part of CPU 862. However, there are many different ways in which memory could be coupled to the system.

The interfaces 868 are typically provided as interface cards (sometimes referred to as “line cards”). Generally, they control the sending and receiving of data packets over the network and sometimes support other peripherals used with the router 810. Among the interfaces that may be provided are Ethernet interfaces, frame relay interfaces, cable interfaces, DSL interfaces, wireless interfaces, Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control such communications intensive tasks as packet switching, media control and management. By providing separate processors for the communications intensive tasks, these interfaces allow the master microprocessor 862 to efficiently perform routing computations, network diagnostics, security functions, etc.

Although the system shown in FIG. 8 is one specific network device of the present invention, it is by no means the only network device architecture on which the present invention can be implemented. For example, an architecture having a single processor that handles communications as well as routing computations, etc. is often used. Further, other types of interfaces and media could also be used with the router.

Regardless of the network device's configuration, it may employ one or more memories or memory modules (including memory 861) configured to store program instructions for the general-purpose network operations and mechanisms for roaming, route optimization and routing functions described herein. The program instructions may control the operation of an operating system and/or one or more applications, for example. The memory or memories may also be configured to store tables such as mobility binding, registration, and association tables, etc.

FIG. 9A and FIG. 9B illustrate example system embodiments. The more appropriate embodiment will be apparent to those of ordinary skill in the art when practicing the present technology. Persons of ordinary skill in the art will also readily appreciate that other system embodiments are possible.

FIG. 9A illustrates a conventional system bus computing system architecture 900 wherein the components of the system are in electrical communication with each other using a bus 905. Exemplary system 900 includes a processing unit (CPU or processor) 910 and a system bus 905 that couples various system components including the system memory 915, such as read only memory (ROM) 970 and random access memory (RAM) 975, to the processor 910. The system 900 can include a cache of high-speed memory connected directly with, in close proximity to, or integrated as part of the processor 910. The system 900 can copy data from the memory 915 and/or the storage device 930 to the cache 917 for quick access by the processor 910. In this way, the cache can provide a performance boost that avoids processor 910 delays while waiting for data. These and other modules can control or be configured to control the processor 910 to perform various actions. Other system memory 915 may be available for use as well. The memory 915 can include multiple different types of memory with different performance characteristics. The processor 910 can include any general purpose processor and a hardware module or software module, such as module 1 937, module 7 934, and module 3 936 stored in storage device 930, configured to control the processor 910 as well as a special-purpose processor where software instructions are incorporated into the actual processor design. The processor 910 may essentially be a completely self-contained computing system, containing multiple cores or processors, a bus, memory controller, cache, etc. A multi-core processor may be symmetric or asymmetric.

To enable user interaction with the computing device 900, an input device 945 can represent any number of input mechanisms, such as a microphone for speech, a touch-sensitive screen for gesture or graphical input, keyboard, mouse, motion input, speech and so forth. An output device 935 can also be one or more of a number of output mechanisms known to those of skill in the art. In some instances, multimodal systems can enable a user to provide multiple types of input to communicate with the computing device 900. The communications interface 940 can generally govern and manage the user input and system output. There is no restriction on operating on any particular hardware arrangement and therefore the basic features here may easily be substituted for improved hardware or firmware arrangements as they are developed.

Storage device 930 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 975, read only memory (ROM) 970, and hybrids thereof.

The storage device 930 can include software modules 937, 934, 936 for controlling the processor 910. Other hardware or software modules are contemplated. The storage device 930 can be connected to the system bus 905. In one aspect, a hardware module that performs a particular function can include the software component stored in a computer-readable medium in connection with the necessary hardware components, such as the processor 910, bus 905, display 935, and so forth, to carry out the function.

FIG. 9B illustrates an example computer system 950 having a chipset architecture that can be used in executing the described method and generating and displaying a graphical user interface (GUI). Computer system 950 is an example of computer hardware, software, and firmware that can be used to implement the disclosed technology. System 950 can include a processor 955, representative of any number of physically and/or logically distinct resources capable of executing software, firmware, and hardware configured to perform identified computations. Processor 955 can communicate with a chipset 960 that can control input to and output from processor 955. In this example, chipset 960 outputs information to output 965, such as a display, and can read and write information to storage device 970, which can include magnetic media, and solid state media, for example. Chipset 960 can also read data from and write data to RAM 975. A bridge 980 for interfacing with a variety of user interface components 985 can be provided for interfacing with chipset 960. Such user interface components 985 can include a keyboard, a microphone, touch detection and processing circuitry, a pointing device, such as a mouse, and so on. In general, inputs to system 950 can come from any of a variety of sources, machine generated and/or human generated.

Chipset 960 can also interface with one or more communication interfaces 990 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 955 analyzing data stored in storage 970 or 975. Further, the machine can receive inputs from a user via user interface components 985 and execute appropriate functions, such as browsing functions by interpreting these inputs using processor 955.

It can be appreciated that example systems 900 and 950 can have more than one processor 910 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims. Moreover, claim language reciting “at least one of” a set indicates that one member of the set or multiple members of the set satisfy the claim.

What is claimed is:

1. A computer-implemented method comprising:
gathering, by a server in a distributed network of application containers, security threat intelligence;
identifying, in the security threat intelligence, a security threat;
automatically identifying an application container that is affected by the security threat;
determining a threat level for the security threat on the application container;
applying a threat mitigation policy on the affected application container based on the threat level;
spawning a clone of the affected application container;
testing one or more security fixes on the clone of the affected application container; and
after the testing is successful, deploying the clone of the affected container as a replacement for the affected container.

2. The computer-implemented method of claim 1, wherein gathering threat intelligence further comprises one or more of: gathering external intelligence relating to an active exploit that affected another application container, processing a vulnerability report from a commercial vendor, processing a vulnerability report from a governmental organization, and analyzing local indicators of compromise.

3. The computer-implemented method of claim 2, wherein automatically identifying an application container that is affected by the security threat further comprises:
correlating the threat intelligence with local indicators of compromise to identify affected application containers.

4. The computer-implemented method of claim 1, further comprising:
gathering information relating to the operating environment of the affected application container.

5. The computer-implemented method of claim 4, further comprising: applying the information relating to the operating environment of the affected application container when determining a threat level for the security threat on the application container.

6. The computer-implemented method of claim 4, further comprising applying the information relating to the operating environment of the affected application container to the clone of the affected application container, wherein testing one or more security fixes on the clone of the affected application container further comprises testing the clone of the application container in accordance with the information relating to the operating environment of the affected application container.

7. The computer-implemented method of claim 1, further comprising:
after identifying a security threat, determining that a security patch is available for addressing the security threat; and
deploying the security patch to the affected application container.

8. The computer-implemented method of claim 1, wherein applying a threat mitigation policy on the affected application container involves one or more of:
hardening an access policy for the affected application container, encrypting a database for the affected application container, suspending a service offered by the affected application container, and shutting down the affected application container.

9. A system in a distributed network of application containers comprising:
a processor; and
a computer-readable storage medium having stored therein instructions which, when executed by the processor, cause the processor to perform operations comprising:
gathering security threat intelligence;
identifying, in the security threat intelligence, a security threat;
automatically identifying an application container that is affected by the security threat;
determining a threat level for the security threat on the application container;
applying a threat mitigation policy on the affected application container based on the threat level;
spawning a clone of the affected application container;
testing one or more security fixes on the clone of the affected application container; and
after the testing is successful, deploying the clone of the affected container as a replacement for the affected container.

10. The system of claim 9, wherein the instruction further cause the processor to perform operations comprising:
gathering information relating to the operating environment of the affected application container.

11. The system of claim 10, wherein the instruction further cause the processor to perform operations comprising:
applying the information relating to the operating environment of the affected application container when determining a threat level for the security threat on the application container.

12. The system of claim 10, wherein the instruction further cause the processor to perform operations comprising:
applying the information relating to the operating environment of the affected application container to the clone of the affected application container, wherein testing one or more security fixes on the clone of the affected application container further comprises testing the clone of the application container in accordance with the information relating to the operating environment of the affected application container.

13. The system of claim 9, wherein applying a threat mitigation policy on the affected application container involves one or more of: hardening an access policy for the affected application container, encrypting a database for the affected application container, suspending a service offered by the affected application container, and shutting down the affected application container.

14. A non-transitory computer-readable storage medium having stored therein instructions which, when executed by a processor, cause the processor to perform operations comprising
gathering security threat intelligence;
identifying, in the security threat intelligence, a security threat;
automatically identifying an application container that is affected by the security threat;
determining a threat level for the security threat on the application container;
applying a threat mitigation policy on the affected application container based on the threat level;
spawning a clone of the affected application container;
testing one or more security fixes on the clone of the affected application container; and
after the testing is successful, deploying the clone of the affected container as a replacement for the affected container.

15. The non-transitory computer-readable storage medium of claim 14, wherein the instruction further cause the processor to perform operations comprising:
gathering information relating to the operating environment of the affected application container.

16. The non-transitory computer-readable storage medium of claim 15, wherein the instruction further cause the processor to perform operations comprising:
applying the information relating to the operating environment of the affected application container when determining a threat level for the security threat on the application container.

17. The non-transitory computer-readable storage medium of claim 15, wherein the instruction further cause the processor to perform operations comprising:
applying the information relating to the operating environment of the affected application container to the clone of the affected application container, wherein testing one or more security fixes on the clone of the affected application container further comprises testing the clone of the application container in accordance with the information relating to the operating environment of the affected application container.

18. The non-transitory computer-readable storage medium of claim 14, wherein applying a threat mitigation policy on the affected application container involves one or more of: hardening an access policy for the affected application container, encrypting a database for the affected application container, suspending a service offered by the affected application container, and shutting down the affected application container.

19. A computer-implemented method comprising:
identifying a security threat for an application container;
spawning a clone of the affected application container;
testing one or more security fixes on the clone of the affected application container; and
deploying the clone of the affected container as a replacement for the affected container.

20. A computer-implemented method comprising:
gathering threat intelligence;
correlating the threat intelligence to identify a security threat;
automatically identifying an application container that is affected by the security threat;
determining a threat level for the security threat on the application container;
applying a threat mitigation policy on the affected application container based on the threat level.
